(19) United States
(12) Patent Application Publication
(10) Pub. No.: US 2009/0212898 A1
(43) Pub. Date: Aug. 27, 2009

(54) MOUNTING ASSEMBLY

(75) Inventors: Jorge R. Montante, Cicero, IL (US); David A. Hervas, Arlington Heights, IL (US)

Correspondence Address: MARSHALL, GERSTEIN & BORUN LLP (S & C), 233 S. WACKER DRIVE, SUITE 6300, SEARS TOWER, CHICAGO, IL, 60606-6357, US

(73) Assignee: S & C ELECTRIC CO., Chicago, IL (US)

(21) Appl. No.: 12/367,925

(22) Filed: Feb. 9, 2009

Related U.S. Application Data
(60) Provisional application No. 61/031,151, filed on Feb. 25, 2008.

(51) Int. Cl. H01H 71/20

(52) U.S. Cl. 337/171

(57) ABSTRACT

A mounting assembly includes a trunnion body portion and a coupled guiding member. The guiding member may be a spring or spring like and may further include a blocking structure. The trunnion body portion may include a loop.

### CROSS-REFERENCES TO RELATED APPLICATIONS

The present application claims priority to Provisional patent application No. 61/031,151, filed on Feb. 25, 2008, which is incorporated by reference in its entirety.

### TECHNICAL FIELD

This patent relates to power distribution systems. In particular, this patent relates to a mounting assembly including a trunnion and a guiding member that permits mounting of a fault protection device in one or more standard cutout mounting configurations.

### BACKGROUND

Fault protection devices, such as the Tripsaver™ Dropout Recloser available from S&C Electric Company of Chicago, Ill. can provide fault protection functionality over a wide range of supply voltages and fault currents. For example, a Tripsaver fault protection device having a single physical configuration can be operably configured for use in systems from 15 kilovolt (kV) or less to in excess of 25 kV.

One advantage of the Tripsaver fault protection device is that it can be retrofitted into power distribution systems in place of existing fault protection devices. The Tripsaver fault protection device is configurable over wide range of operating parameters, and it advantageously has a single physical form factor. Unfortunately, the cutout mountings for various legacy fault protection devices are not uniformly sized or configured. Another advantage of the Tripsaver fault protection device is that it is easily installed using a hot stick or other suitable device. Once again, however, the nonuniform size of the cutout mountings can make installation difficult in spite of the thoughtful engineering of the Tripsaver device.

### BRIEF DESCRIPTION OF THE DRAWINGS

FIG. 1 is a graphic illustration of a fault protection device positioned within a cutout mounting and including a mounting trunnion in accordance with one or more embodiments of the invention.

FIG. 2 is a graphic illustration of a fault protection device positioned partially within a cutout mounting in an open position with the device pivoting on a mounting trunnion in accordance with one or more embodiments of the invention.

FIG. 3 is a graphic illustration of a fault protection device positioned partially within a cutout mounting in an open position with the device pivoting on a mounting trunnion which may include a blocking structure in accordance with one or more embodiments of the invention.

FIG. 4 is a perspective view of a trunnion in accordance with one or more embodiments of the invention.

FIG. 5 is a side view of guiding member in accordance with one or more embodiments of the invention.

FIG. 6 is a plan view of the guiding member of FIG. 5.

### DETAILED DESCRIPTION

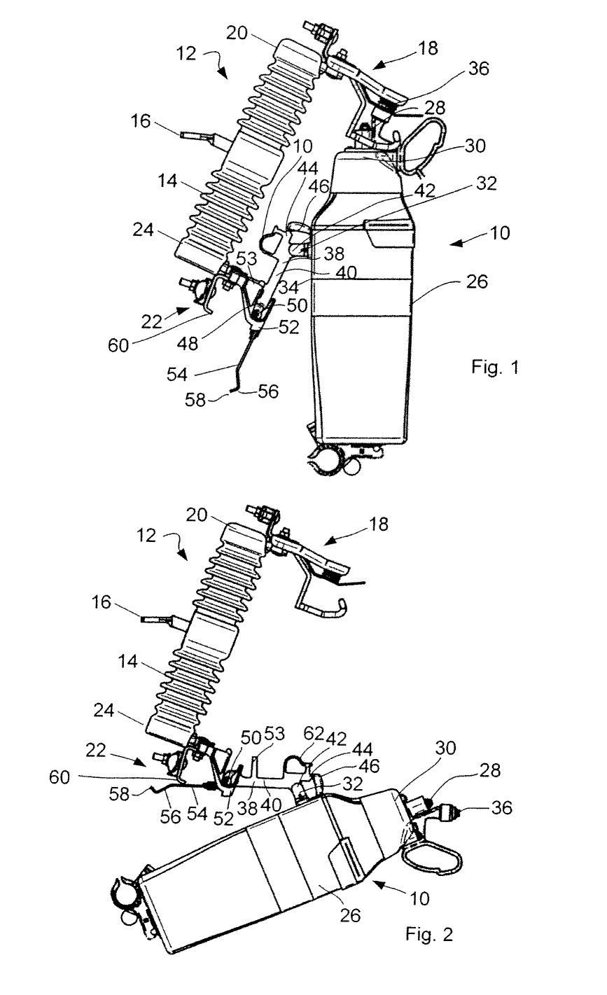

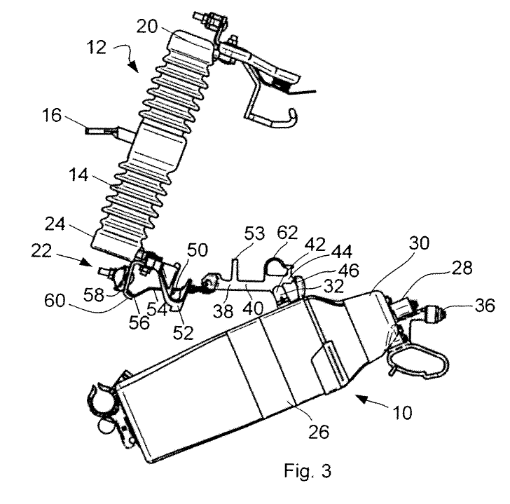

FIG. 1 illustrates a fault protection device 10 positioned within a cutout mounting 12 of a power distribution system (not depicted). The cutout mounting 12 includes an insulator 14 and a mounting bracket 16 secured to or formed on the insulator to allow the cutout mounting to be secured to a pole or other suitable structure. The cutout mounting 12 includes a contact assembly 18 secured to or formed on one end 20 of the insulator 14, and a contact assembly 22 secured to or formed on the other end 24 of the insulator 14. In this regard the cutout mounting 12 is typical, although the particular configuration of the insulator 14, contact assembly 18 and contact assembly 22 may differ based upon the manufacturer, cutout mounting rating (15 kV, 25 kV, etc.) and other considerations.

The fault protection device 10 includes a device body 26, a contact structure 28 at an end 30 of the body 26 and a contact/trunnion mounting structure 32 extending from a side 34 of the body 26. The contact structure 28 may include a post-like structure 36 extending from the end 30 adapted to engage the contact assembly 18. The structures 28 and 32 couple to operative elements disposed within the body 26 (not depicted) to affect fault isolation and service restoration. The fault isolation and service restoration features of the fault protection device 10 are not germane to the instant invention, and further description is not provided. However, a complete description of a suitable fault protection device may be found in the commonly assigned International Patent Application Serial No. PCT/US2006/044547 filed on Nov. 17, 2006, the disclosure of which is hereby expressly incorporated herein for all purposes.

A mounting assembly 40 including a trunnion body portion 38 is coupled to the contact/trunnion mounting structure 32 at a first pivot 42 and for example by a pivot pin (not depicted). The trunnion body portion 38 is formed to include a catch member 44 that is engaged by a latch 46 that is operatively coupled to the device 10. Releasing of the latch 46 from the catch member 44 allows pivoting of the device 10 about the pivot 42 to initiate a transition of the device 10 from a closed position (FIG. 1) to an open position (FIG. 2) in accordance with the unique operating characteristics of the device 10.

At an end 48 opposite the catch member 44, the trunnion body portion 38 includes a second pivot 50 that engages a hinge 52 secured to or formed integral with the contact assembly 22. The device 10 is therefore also rotatable about the second pivot 50 such that the device is able to transition from the closed position to the open position and vice versa. The trunnion body portion 38 also includes a tab member 53 that engages the contact assembly 22 to assist positioning of the device 10 in the closed position.

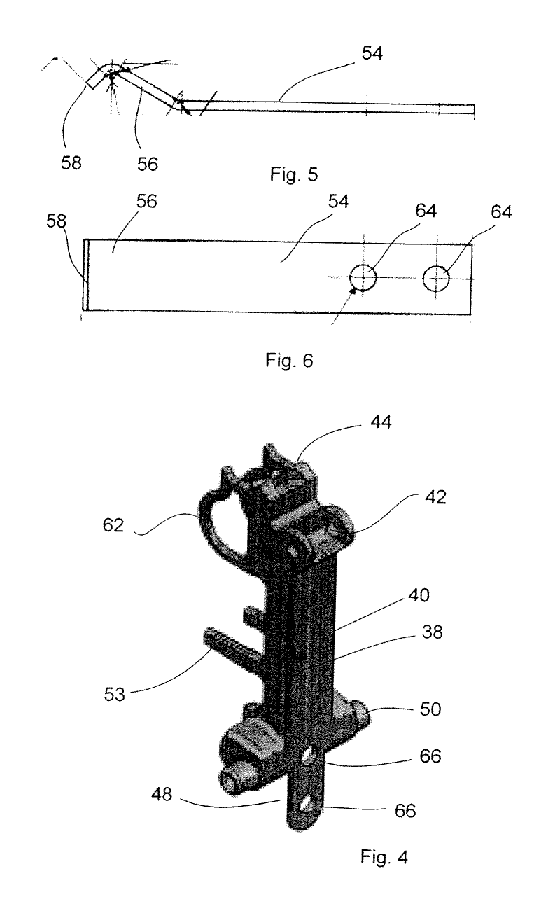

The mounting assembly 40 further includes secured to or formed integral with the trunnion body portion 38 a guiding tail 54. The guiding tail 54 may be formed integrally with the trunnion body portion 38 as a single casting, machined part or similar structure. Alternatively, the guiding tail 54 may be secured to the trunnion body portion 38 by threaded fastener, riveting, welding, bonding or by any suitable form of attachment. As depicted in FIGS. 4-6, the trunnion body portion 38 may be formed with apertures 66 and the guiding member 54 may be formed with apertures 64 allowing the guiding member 54 to be coupled to the trunnion body portion 38 by threaded fasteners and/or rivets.

The guiding tail 54 as depicted in FIGS. 5 and 6 may be an elongate flat member including a width, a thickness and a length. The guiding tail 54 may be made from a suitable metal flat stock and may be made from spring grade flat stock metal providing the guiding member with spring-like ability. In a preferred embodiment, the guiding tail 54 may be made from a phosphor bronze alloy that is heat treated to provide a spring temper.

The guiding tail 54 extends through an aperture (not depicted), such as a slot or other suitable opening formed in the contact assembly 22. The aperture preferably is configured to allow the guiding tail 54 to extend freely through the aperture but to still provide sufficient guiding of the device 10/mounting assembly 40 such that the pivot 50 engages the hinge 52.

The guiding tail 54 facilitates installation of the device 10 into the cutout mounting 12. The guiding tail 54 is inserted through the aperture guiding the device 10/mounting assembly 40 toward the contact assembly 22 and the pivot 50 into the hinge 52. In this regard, the guiding tail 54 acts similar to a pilot. Additionally, engagement of the guiding member 54 with a flange 60 of the contact assembly 22 assists in balancing the device 10 as the installer positions the device 10 into the cutout mounting 12.

An end portion 56 of the guiding tail 54 may be formed with a blocking structure 58 to prevent improper insertion of the mounting assembly 40 into the contact assembly 22. The blocking structure 58 may be an offset or angled feature formed at the end portion 56. In such an embodiment, as depicted in the figures, the blocking structure 58 may be a “V” shaped angled structure. The blocking structure 58 engages an upper portion of the flange 60 upon insertion of the guiding tail 54 through the aperture if the angle of the device is incorrect to affect proper insertion of the pivot 50 into the hinge 52. The blocking structure 58 may be any suitable shape to affect such blocking, including a single angled surface or chamfer, a bended tab, an arc, a loop or similar shapes.

As noted, the guiding member 54 may be a spring or spring-like. In preferred embodiments the guiding member 54 may be made from spring tempered phosphor bronze allow. During drop of the device 10, the guiding member engages the flange 60 and cushioning the device 10 but also providing a rebound of the device that assists in automatically resetting the latch 46 to the catch member 44.

As described the mounting assembly 40 including a trunnion body portion 38 couple to a guiding member 54 facilitates insertion of the device 10 into a cutout mounting 12. The trunnion body portion 38 additionally may include a ring or loop 62. The loop 62 may be engaged with a hot stick or similar device to facilitate insertion of the guiding member 54 into the contact assembly 22 and ultimately the device 10 into the cutout mounting 12. The loop 62 may be circular, elliptical or otherwise shaped. Additionally, the loop 62 may be continuous or discontinuous or slotted.

While the invention is described in terms of several preferred embodiments of mounting assemblies that may be used in connection with fault protection devices, it will be appreciated that the invention is not limited to such devices. The inventive concepts may be employed in connection with any number of devices and structures. Moreover, while features of various embodiments are shown and described in combination, the features may be implemented individually each such single implementation being within the scope of the invention.

While the present disclosure is susceptible to various modifications and alternative forms, certain embodiments are shown by way of example in the drawings and the herein described embodiments. It will be understood, however, that this disclosure is not intended to limit the invention to the particular forms described, but to the contrary, the invention is intended to cover all modifications, alternatives, and equivalents defined by the appended claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

We claim:

1. A mounting assembly for a fault protection device comprising:
a trunnion body;
a fault protection device mounting structure formed on the trunnion body;
a pivot formed on the trunnion body; and
a guiding member extending from the trunnion body.

2. The mounting assembly of claim 1, wherein the guiding member comprises a spring.

3. The mounting assembly of claim 1, wherein the guiding member comprises a blocking structure.

4. The mounting assembly of claim 3, wherein the blocking structure comprises an angled end portion of the guiding member.

5. The mounting assembly of claim 3, wherein the blocking structure comprises a “V” shaped angled end portion of the guiding member.

6. The mounting assembly of claim 1, wherein the guiding structure is fastened to the trunnion body.

7. The mounting assembly of claim 1, wherein the guiding structure is formed integral with trunnion body.

8. The mounting assembly of claim 1 comprising a loop structure extending from the trunnion body

9. The mounting assembly of claim 8 wherein the loop structure comprises an enclosed ring.

10. The mounting assembly of claim 8 wherein the loop structure comprises an open ring.
